(19) United States
(12) Patent Application Publication
(10) Pub. No.: US 2010/0019417 A1
(43) Pub. Date: Jan. 28, 2010

(54) DEVICE AND METHOD FOR CURING HEARING AID HOUSINGS

(75) Inventors: Tze Peng Chua, Singapore (SG); Matthias Jorgas, Nürnberg (DE); Harald Klemenz, Singapore (SG); Eng Cheong Lim, Singapore (SG); Pei Chyi Kristy Lim, Singapore (SG); Nisha Shakila Ma, Singapore (SG)

Correspondence Address: LERNER GREENBERG STEMER LLP, P O BOX 2480, HOLLYWOOD, FL, 33022-2480, US

(73) Assignee: SIEMENS MEDICAL INSTRUMENT PTE. LTD., Singapore (SG)

(21) Appl. No.: 12/509,519

(22) Filed: Jul. 27, 2009

(30) Foreign Application Priority Data
Jul. 25, 2008 (DE) 10 2008 034 712.4

(51) Int. Cl. B29C 35/08

(52) U.S. Cl. 264/494; 425/174.4; 264/405

(57) ABSTRACT

A device and a method for curing plastic moldings are particularly suited for curing hearing aid housings. A light source emits curing light and a holder, at least partially transparent to curing light, holds the plastic moldings. The holder has an elongate light guiding element, which is transparent to curing light, which has an emission portion for emitting curing light in a number of spatial directions, and which is formed in such a way that at least the emission portion can protrude into a convex curvature or an interior space of a plastic molding that is being held by the holder. The light guiding element guides curing light emitted from the light source to the emission portion and emits from there. The light guiding element may have a holding portion for holding the plastic molding. The holding portion and the emission portion may spatially overlap. The method includes a step of irradiating the plastic molding with curing light simultaneously on the outside and the inside by the light source and by the light guiding element. Particularly uniform curing without localized temperature peaks is achieved.

### CROSS-REFERENCE TO RELATED APPLICATION

This application claims the priority, under 35 U.S.C. § 119, of German patent application DE 10 2008 034 712.4, filed Jul. 25, 2008; the prior application is herewith incorporated by reference in its entirety.

### BACKGROUND OF THE INVENTION

### Field of the Invention

The invention relates to a device and a method for curing plastic moldings, in particular hearing aid housings.

Plastic moldings, in particular hearing aid housings, are generally produced in a number of method steps, one of which is the provision of a molding in which, though it has been shaped, the plastic has not yet been cured. The final method step, that of the curing, usually takes place by exposing the molding to be cured to heat. In addition, the curing process may be assisted by light of a wavelength that causes chemical curing reactions. The curing process is accompanied by structural changes of the plastic, which may cause minimal changes in the volume and form of the molding. If the plastic molding is not heated, i.e., cured, completely uniformly, internal stresses and deformations may therefore occur.

International published patent application WO 03/074248 A1 describes an apparatus for producing hearing aid housings using light-curable plastics. The apparatus has an irradiation chamber, which is filled with an inert gas, for example argon, to avoid oxidation reactions. Hearing aid housings to be cured are irradiated in this irradiation chamber by a UV light source. The UV light source is of a conventional kind, for example a 400 W metal-halide lamp. The housing to be irradiated lies on a glass plate above the UV light source. It is therefore irradiated substantially only from one direction, that is from below.

Likewise known are devices that have in principle the construction represented in FIG. 1. The device 30 represented in FIG. 1 for curing a hearing aid housing 20 has a light source 31 of a conventional type of construction for emitting UV light. The light source 31 is arranged underneath a glass plate 32, on which a hearing aid housing 20 to be cured is arranged. A hearing aid housing 20 lies on the glass plate 32. To achieve more uniform irradiation, and consequently curing, of the hearing aid housing 20, arranged above is a mirror 33, which reflects UV light from the light source 31 in the direction of the hearing aid housing 20. This also allows portions of the housing that are facing away from the light source 31 to be irradiated. However, a disadvantage of this device is that, although plastic moldings of complex forms are irradiated from a number of sides by the mirror 33, there are nevertheless still portions of the housing that are not reached by the light, at least not directly. This applies in particular to parts of concave curvatures and of the interior space of the housing 20.

A further disadvantage is that the housing 20 is in direct contact with the glass plate 32. The glass plate 32 is heated up by the light source 31. At the points at which the housing 20 is in direct contact with the glass plate 32, localized temperature peaks therefore occur, additionally making the curing process less homogeneous. This effect is exacerbated by the fact that no convection movement of the air or of the inert gas atmosphere is possible at the contact points, which further increases the localized temperature peaks. What is more, the inert gas atmosphere can break down at the contact points and, with the lack of movement of the inert gas, is not renewed. This leads to increasing oxide film formation at the contact points.

### SUMMARY OF THE INVENTION

It is accordingly an object of the invention to provide a device and a method for curing plastic moldings, in particular hearing aid housings, which overcome the above-mentioned disadvantages of the heretofore-known devices and methods of this general type and which provide a curing process that is ensured to be more uniform. A further object of the invention is to reduce the formation of oxide films on the plastic molding during the curing process. An additional object of the invention is to make it possible for even small housings with little base area to be cured.

With the foregoing and other objects in view there is provided, in accordance with the invention, a device for curing a plastic molding, comprising:
a light source configured to emit curing light of a predetermined wavelength or a predetermined wavelength range;
a holder for holding the plastic moldings, the holder being at least partially transparent to the curing light;
the holder having an elongate light guiding element, the elongate light guiding element:
   being transparent to the curing light;
   having an emission portion configured to emit curing light in a plurality of spatial directions; and
   being formed such that at least the emission portion projects into a convex curvature or an interior space of the plastic molding being held by the holder.

In other words, a basic concept of the device-related aspect of the invention is that of providing a device for curing a plastic molding, comprising a light source for emitting curing light of a predetermined wavelength or a predetermined wavelength range, and a holder, transparent to curing light, for holding the plastic moldings, the holder having an elongate light guiding element, which is transparent to curing light, which has an emission portion for emitting curing light in a number of spatial directions, and which is formed in such a way that at least the emission portion can protrude into a convex curvature or an interior space of a plastic molding that is being held by the holder.

The fact that the light guiding element makes it possible for even convex curvatures or interior spaces to be irradiated with curing light means that altogether more uniform irradiation is achieved. This brings about more uniform curing over the plastic molding as a whole. The more uniform curing has the effect that internal stresses and deformations of the plastic molding are reduced. This advantage can be achieved in particular for plastic moldings of a complex form that have twisted or curved or angled interior spaces.

In an advantageous development, the device is designed for curing hearing aid housings.

For this purpose, the light guiding element simply has to be configured in a size and form that are adapted to the hearing aid housing. Hearing aid housings, in particular ITE (in-the-ear) housings and CiC (completely-in-the-canal) housings, often have linked or angled interior spaces, so that they profit especially from the irradiation on both sides by the light guiding element with regard to a uniform curing process.

In a further advantageous development, the light guiding element is designed for guiding curing light emitted from the light source to the emission portion.

This makes it possible to dispense with additional light sources for or in the light guiding element, which simplifies the construction of the device. This makes the device more favorable in terms of production and costs.

In a further advantageous development, the emission portion consists of a material that scatters curing light in a number of spatial directions.

A material with suitable refractive properties may be chosen for this, for example, so that the entire emission portion of the light guiding element can be formed from this material. This obviates the need for special design features for deflecting or reflecting the curing light. This gives rise to a particularly simple construction of the light guiding element, which may for example be produced in one piece in a two-component injection-molding process. Instead, the emission portion could also be integrated as a separate component in the light guiding element, which however would require special consideration for the optical boundary surface between the emission portion and the other portion of the light guiding element. Irrespective of the structural design, the emission portion using scattering to produce diffuse light, which irradiates the interior space or the curvature of the plastic molding in a number of or all spatial directions.

In a further advantageous development, the emission portion comprises one or more emission mirrors, which reflect curing light in a number of spatial directions.

The use of emission mirrors for reflecting the curing light allows a deliberate reflection of light in one or more desired spatial directions. In particular in the case of highly angled interior spaces, such a portion representing an arm or angle can be irradiated more intensively with curing light.

In a further advantageous development, the light guiding element comprises a holding portion, which is designed for holding the plastic molding.

Such a holding portion could already be obtained by the end portion or the end of the light guiding element that reaches into the interior space or the curvature of the plastic molding being shaped in a round form with a large surface area, avoiding points or edges. This gives rise to a larger supporting surface, which avoids unwanted deformations of the plastic molding. A particular advantage of the light guiding element being formed with a holding portion, and consequently being formed as an additional holding element, is that a plastic molding that is held by the light guiding element no longer needs to rest on the glass plate or base plate of the device. As a result, localized temperature peaks and a breakdown of the inert gas atmosphere at such contact points are avoided. As a result, a more uniform curing process is achieved and the formation of oxide films owing to the lack of inert gas atmosphere is reduced. Furthermore, forms of housing with a small base area, which tend to fall over on a base plate, can be held without any problem by the light guiding and holding element. In this way it is also ensured for such forms of housing that curing light gets into the interior space.

In a further advantageous development, the holding portion and the emission portion spatially overlap, at least partially.

This gives rise to a simple construction of the light guiding element and the emission takes place in particular also in the region of the holding portion, thereby avoiding localized areas of coverage that are not reached by curing light, at the contact points of the holding portion and the plastic molding.

In a further advantageous development, a mirror for reflecting curing light is provided, the holder being arranged between the light source and the mirror, and the mirror being aligned in such a way that it reflects curing light in the direction of the holder.

The arrangement of the mirror also has the effect that the outer irradiation of the plastic molding is extended to a number of directions of irradiation. As a result, the outer side of the plastic molding is cured more uniformly.

In a further advantageous development, the light source emits curing light of a wavelength in the UV wavelength range.

For many polymers, curing by UV light is particularly suitable and is a tried-and-tested procedure. Hearing aid housings in particular usually consist of polymers that are cured by UV light, and therefore profit especially from the use of UV light for the process. UV light sources are already known and available.

In a further advantageous development, the holder comprises a base plate that is at least partially transparent to curing light, the base plate being arranged between the light guiding element and the light source, and the base plate being heated up by curing light.

The base plate is heated up as a result of the partial transparency of the base plate, or to be more precise as a result of the partial absorption of UV light. The heating contributes to the curing process, the base plate representing a heating plate that is larger in terms of its surface area, thereby avoiding localized areas of heating up by the UV light source of a smaller surface area.

In a further advantageous development, the light source and the base plate are made to match one another in such a way that the base plate is heated up by curing light emitted from the light source to a temperature of from 55° C. (degrees Celsius) to 65° C.

Temperatures in the range of 60° C. are particularly well suited for the curing of plastics, in particular of polymers that are used for hearing aid housings.

With the above and other objects in view there is also provided, in accordance with the invention, a method of curing a plastic molding which comprises the following method steps:
providing a light source for emitting curing light;
providing an elongate light guiding element configured to emit curing light in a number of spatial directions;
introducing the light guiding element into a convex curvature or an interior space of the plastic molding; and
irradiating the plastic molding with curing light simultaneously on the outside and the inside by the light source and by the light guiding element.

The method makes particularly uniform curing possible, by the plastic molding being irradiated with curing light as uniformly as possible from the outside and from the inside. In addition, the irradiation takes place simultaneously, i.e. in a single working step, thereby avoiding additional method steps for changing the direction of irradiation and for changing the alignment of the plastic molding that could otherwise bring about more uniform irradiation. Consequently, the method is less complicated and saves time. Since localized differences in the radiation intensity are reduced as a result of the more uniform irradiation, the radiation intensity can be additionally increased without causing an unacceptable increase in internal stresses or deformations in the plastic molding. The increased radiation intensity may have the effect of further speeding up the method.

In an advantageous development, the plastic molding is a hearing aid housing.

Hearing aid housings profit especially from the method, on account of their often angled or twisted form, for example of ITC housings or CiC housings.

Other features which are considered as characteristic for the invention are set forth in the appended claims.

Although the invention is illustrated and described herein as embodied in a device and method for curing hearing aid housings, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a curing device according to the prior art;

FIG. 2 shows a device according to the invention;

FIG. 3 shows a light guiding element with a holding portion; and

FIG. 4 shows a light guiding element with emission mirrors.

### DETAILED DESCRIPTION OF THE INVENTION

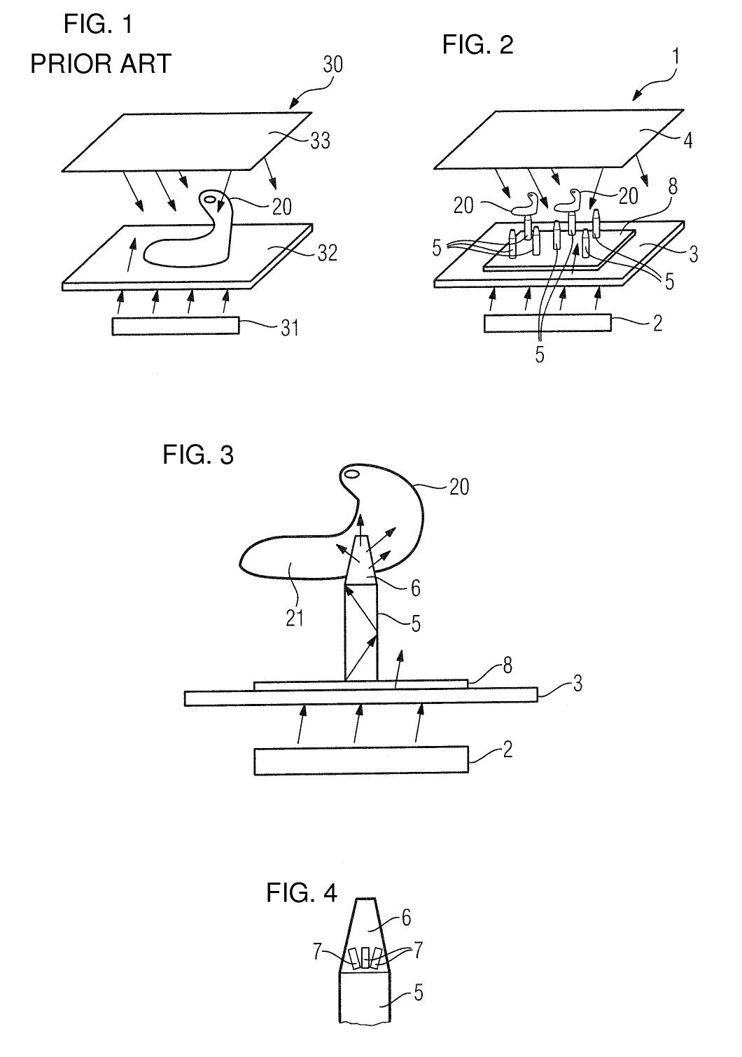

Referring now to the figures of the drawing in detail and first, particularly, to FIG. 1 thereof, there is shown a prior-art device 30 for curing plastic moldings, which has already been described above. Although it allows irradiation of a plastic molding 20, for example a hearing aid housing or shell, from two directions, it does not make irradiation possible from all sides if the body has concave curvatures or interior spaces with branches or twists.

Represented in FIG. 2 is a device for curing a plastic molding 20 that forms an exemplary embodiment of the invention and makes use of the basic concept of the invention.

The device 1 comprises a light source 2, which emits curing light. An advantageous embodiment provides that light in the ultraviolet wavelength range, that is UV light, is used as the curing light. UV light sources are known and commercially available.

The light source 2 emits curing light in the upward direction in the figure, the direction of radiation being indicated by arrows that are not designated any more specifically. The curing light first impinges on a glass plate 3, which is at least partially transparent to light of the corresponding wavelengths. Arranged on the glass plate 3 is a base plate 8, which is likewise at least partially transparent to the curing light. Arranged on the base plate 8, which may likewise be produced from glass, are a number of light guiding elements 5. The light guiding elements 5 and the base plate 8 form a holder for holding plastic moldings that are to be cured in the device 1 by irradiation. Depending on the structural design of the device 1 or of the holder, the glass plate 3 is also a component part of the holder. It may, however, also be detached from the holder, so that the holder formed by the base plate 8 and the light guiding elements 5 is merely placed on the glass plate 3. The configuration and function of the light guiding elements 5, which serve at the same time as holding elements, are explained in more detail in the following description of the figures.

The curing light emitted from the light source 2 passes through the glass plate 3 and the base plate 8 and partially impinges on the plastic moldings 20 to be cured, here hearing aid housings. Other components of the light continue substantially unhindered and impinge on the mirror 4 arranged at the top in the figure. The curing light is reflected by the mirror 4 in the direction of the housings to be cured and the glass plate 3. As a result, irradiation of the housings from at least two directions, in the figure from below and from above, is achieved. This brings about a more uniform irradiation of the housings, and consequently a more uniform curing process.

The space between the base plate 3 and the mirror 4 may be configured as a component part of a gastight chamber, which may be filled with inert gas for carrying out the curing process. Argon may be advantageously used, for example, as the inert gas. Oxidation processes in the material to be cured are reduced by the inert gas atmosphere in the chamber in which the curing takes place.

FIG. 3 illustrates a light guiding element 5 of the device 1 explained above, in an enlarged format.

As in the previous figure, the light source 2 is arranged at the bottom, above it are the glass plate 3 and the base plate 8 that are partially transparent to the emitted light. The direction of the curing light is indicated by arrows.

Arranged on the base plate 8 is the light guiding element 5. Curing light passes through the glass plate 3 and the base plate 8 and partially impinges on the light guiding element 5. Components of the curing light that impinge there enter the light guiding element 5. To this extent, the curing light first passes through the boundary surface with respect to the glass plate 3, then to the base plate 8, then into the light guiding element 5. To reduce unwanted losses caused by scattering or reflection at the respective boundary surfaces, these elements may also consist of materials that are suitably made to match one another or of the same material. Moreover, the boundary transitions may be appropriately worked and connected to one another. To avoid radiation losses as much as possible, the glass plate 3, the base plate 8 and the light guiding elements 5 may, however, also be produced in one piece. As a result, boundary surface transitions after entry into the glass plate 3 are avoided.

Curing light that has entered the light guiding element 5 is longitudinally reflected inside the latter and thereby guided along the light guiding element 5. The longitudinal reflection is once again indicated by arrows.

As a result, the curing light is guided into the emission portion 6 of the light guiding element 5. The emission portion 6 may be connected to the rest of the light guiding element 5 in one piece, for example by a two-component injection-molding process. It may, however, also be produced as a separate piece and be placed on, appropriate precautions having to be taken to avoid radiation losses by reflection and refraction at the boundary surface.

The emission portion consists of a material that has a scattering effect for the curing light. The scattered light is emitted in a multiplicity of spatial directions. As a result, multiply scattered, diffuse curing light is radiated into the surrounding space.

The plastic molding 20 to be cured, here a hearing aid housing, is placed on the emission portion 6 and is held by it. For this purpose, the emission portion 6 is at the same time formed as a holding element. It has for this purpose a dimensioning that is adapted to the interior space 21 of the hearing aid housing 20. Moreover, it does not have any sharp edges or acute angles, which would lead to deformations of the housing lying on it. Rather, the emission portion 6 is shaped in such a way that the housing 20 can lie on it with a uniform supporting force, without pressure points.

As a result of the simultaneous holding function of the emission portion 6, the latter protrudes into the interior space of the housing 20, so that it is held with the opening of the interior space in the direction of the light source 2. It is consequently positioned in suitable alignment, and prevented from tipping or falling over, by the light guiding element 5. Moreover, the emission portion 6 emits curing light inside the interior space of the housing in a multiplicity of spatial directions, so that uniform irradiation of the interior space is ensured. In particular, the arm or branch of the hearing aid housing 20 that is arranged on the left in the example represented is also reached by the curing light, which would not be possible by irradiation exclusively from the light source 2 and without the emission portion 6 of the light guiding element 5.

FIG. 4 represents another embodiment of the light guiding element 5 or the emission portion thereof. Arranged in the emission portion 6 are emission mirrors 7, which serve for reflecting the curing light. In this case, principal directions for the emission of curing light are predetermined by the alignment of the emission mirrors 7. For example, a configuration in which the emission mirrors 7 particularly emit curing light in the radial direction, whereas in the axial direction curing light particularly enters directly from the light source 2, could be chosen.

Using the device described above, a method for curing plastic moldings, in particular hearing aid housings, that is uncomplicated and saves time can be carried out. In this case, quick and easy, but at the same time reliable, positioning of the hearing aid housings in the irradiation chamber is achieved by only needing to place them onto the light guiding elements 5. The irradiation with curing light takes place in particular on the basis of the light guiding elements 5, or by the emission portions 6, on the inside and on the outside simultaneously, and consequently altogether uniformly distributed over the hearing aid housing as a whole. The uniform intensity distribution ensures a particularly uniform curing process. The uniformity of the process can be used for increasing the overall intensity, in order to speed up the process. Moreover, the irradiation takes place from all sides and directions at the same time, that is to say in a single method step. Additional expenditure of time for further method steps, for example changing the direction of irradiation or the alignment of the hearing aid housings 20, is avoided. On the one hand this saves time, and on the other hand it reduces the complexity of the structural design of the drying device 1.

The basic concept of the invention can be summarized as follows: the invention relates to a device 1 and a method for curing plastic moldings 20, in particular hearing aid housings. The device 1 comprises a light source 2 for emitting curing light and a holder 3, at least partially transparent to curing light, for holding the plastic moldings 20. According to the invention, the holder 3 has an elongate light guiding element 5,

which is transparent to curing light,

which has an emission portion 6 for emitting curing light in a number of spatial directions, and

which is formed in such a way that at least the emission portion 6 can protrude into a convex curvature or an interior space 21 of a plastic molding 20 that is being held by the holder 3.

In an advantageous way, the light guiding element 5 is designed for guiding curing light emitted from the light source 2 to the emission portion 6 and emitting it from there. In a particularly advantageous way, the light guiding element 5 comprises a holding portion, which is designed for holding the plastic molding 20. The holding portion and the emission portion 6 may spatially overlap. The method according to the invention comprises as the essential method step the irradiating of the plastic molding 20 with curing light simultaneously on the outside and the inside by the light source 2 and by the light guiding element 5. Particularly uniform curing without localized temperature peaks is achieved by the invention.

1. A device for curing a plastic molding, comprising:
a light source configured to emit curing light of a predetermined wavelength or a predetermined wavelength range;
a holder for holding the plastic moldings, said holder being at least partially transparent to the curing light;
said holder having an elongate light guiding element, said elongate light guiding element:
being transparent to the curing light;
having an emission portion configured to emit curing light in a plurality of spatial directions; and
being formed such that at least said emission portion projects into a convex curvature or an interior space of the plastic molding being held by said holder.

2. The device according to claim 1, configured for holding and curing hearing aid housings.

3. The device according to claim 1, wherein said light guiding element is configured for guiding the curing light emitted from said light source to said emission portion.

4. The device according to claim 1, wherein said emission portion consists of a material configured to scatter curing light in a plurality of spatial directions.

5. The device according to claim 1, wherein said emission portion comprises one or more emission mirrors configured reflect the curing light in a plurality of spatial directions.

6. The device according to claim 1, wherein said light guiding element comprises a holding portion configured for holding the plastic molding.

7. The device according to claim 6, wherein said holding portion and said emission portion spatially overlap, at least partially.

8. The device according to claim 7, which comprises a mirror for reflecting curing light, and wherein said holder is disposed between said light source and said mirror, and wherein said mirror is aligned to reflect the curing light in a direction towards said holder.

9. The device according to claim 1, wherein said light source emits curing light in the UV wavelength range.

10. The device according to claim 1, wherein said holder comprises a base plate that is at least partially transparent to curing light, and wherein said base plate is disposed between said light guiding element and said light source, and said base plate is heated up by curing light.

11. The device according to claim 10, wherein said light source and said base plate are made to match one another such that said base plate is heated up by curing light emitted from said light source to a temperature from 55° C. to 65° C.

12. A method of curing a plastic molding which comprises the following method steps:
providing a light source for emitting curing light;
providing an elongate light guiding element configured to emit curing light in a number of spatial directions;
introducing the light guiding element into a convex curvature or an interior space of the plastic molding; and
irradiating the plastic molding with curing light simultaneously on the outside and the inside by the light source and by the light guiding element.

13. The method according to claim 12, wherein the plastic molding is a hearing aid housing.

14. The method according to claim 12, which comprises generating curing light in the UV wavelength range.

15. The method according to claim 12, which comprises holding the plastic molding with the light guiding element.
